(19) United States
(12) Patent Application Publication
(10) Pub. No.: US 2004/0139467 A1
(43) Pub. Date: Jul. 15, 2004

(54) Aircraft communication distribution system

(76) Inventors: Michael Rogerson, Irvine, CA (US); Ian McClelland, Irvine, CA (US)

Correspondence Address: STRADLING YOCCO CARLSON & RAUTH, SUITE 1600, 660 NEWPORT CENTER DRIVE, P.O. BOX 7680, NEWPORT BEACH, CA, 92660, US

(21) Appl. No.: 10/607,648

(22) Filed: Jun. 26, 2003

Related U.S. Application Data
(60) Provisional application No. 60/392,000, filed on Jun. 26, 2002.

(51) Int. Cl. H04N 7/18

(52) U.S. Cl. 725/76; 725/77; 725/80; 725/81

(57) ABSTRACT

An aircraft communication distribution system and comprising a media controller to control the system, a media server in communication with the media controller and configured to store media information in a digital format, a web server to access the worldwide web in communication with the media controller, at least one Ethernet tapping unit in communication with the media, at least one Ethernet area distribution box in communication with the media server, at least one display unit in communication with at least one of the Ethernet tapping unit and the Ethernet area distribution box.

### CROSS REFERENCE TO RELATED APPLICATIONS

The present application claims priority to U.S. Provisional Patent Application Serial No. 60/392,000, filed Jun. 26, 2002, U.S. patent application Ser. No. 10/194,429, filed Jul. 11, 2002, and Unites States Provisional Patent Application Serial No. ______, filed Apr. 3, 2003, and entitled “Modular Passenger Audio-Visual, Entertainment and Data Interface System”, each of which are commonly owned by the assignee of the present application and the contents of which are incorporated by reference in their entirety herein.

### BACKGROUND OF THE INVENTION

During flights or other extended periods of travel, entertainment options for passengers have typically been severely limited. Although commercial travel providers such as airlines, cruise ships, and passenger rail service providers have attempted to improve their service by offering in-transit movies, passenger are given little ability to select the content of the video programming that they receive. To improve the quality of the service to the passengers and in response to increased competition among travel providers, many aircraft manufacturers have desired to incorporate an advanced passenger entertainment system into the aircraft cabin. Ideally, each passenger would be capable of accessing a myriad of entertainment choices. Further, each passenger would be capable sending and receiving information in a variety of formats, including, voice communication, data communication, and e-mail communications. In addition, the passengers would be capable of accessing the World Wide Web while in transit.

The difficulty in providing such systems resides in the fact that most passenger conveyances are space-constrained. For example, in-flight entertainment systems and communications systems are afforded very little space within an aircraft fuselage for installation. Further, weight considerations have become a more prevalent design constraint. An increase in vehicle weight results in higher fuel consumption, decreased carrying capacity, increased power consumption, and the like.

Furthermore, commercial passenger conveyances are typically subject to governmental regulation, which may further constrain the design parameters of such in-transit entertainment and communication systems. For example, aircraft environments are tightly controlled by both national and international governing bodies.

In light of the foregoing, the present application discloses an aircraft communication distribution system that overcomes or minimizes the above-mentioned problems.

### BRIEF SUMMARY OF THE INVENTION

An aircraft communication distribution system for distributing communication and information is disclosed.

In one embodiment, an aircraft communication distribution system is disclosed and includes a media controller to control the system, a media server in communication with the media controller and configured to store media information in a digital format, a web server to access the worldwide web in communication with the media controller, at least one Ethernet tapping unit in communication with the media, at least one Ethernet area distribution box in communication with the media server, at least one display unit in communication with at least one of the Ethernet tapping unit and the Ethernet area distribution box.

In another embodiment, a media controller for controlling the distribution of various media across a network is disclosed and includes a memory device, a device for accessing digital information stored within the memory, a high speed loader for loading the digital information stored within the memory device, a system interface configured to couple the media controller to an in-flight entertainment system within an aircraft, a display device in communication with the media controller, and a power source in communication with the media controller and configured to provide power thereto.

In another embodiment, an aircraft communication distribution system is disclosed and includes a media controller to control the system a media server in communication with the media controller and configured to store media information in a digital format, a web server to access the worldwide web in communication with the media controller, at least one display unit in communication with at least one of the media controller and the media server, the display unit having at least one processor, memory device, and display screen therein.

In another embodiment, an aircraft communication distribution system is disclosed and includes a media controller to control the system, a media server in communication with the media controller and configured to store media information in a digital format, a web server to access the worldwide web in communication with the media controller, a network of display units in communication with at least one of the media controller and the media server and other display units with the display unit network, each display unit having at least one processor, memory device, and display screen therein, wherein the network of display units form a distributed server.

### BRIEF DESCRIPTION OF THE DRAWINGS

Various embodiments of an aircraft communication distribution system will be explained in more detail by way of the accompanying drawings, wherein components having similar but not necessarily the same or identical features, may have the same reference numeral, and wherein:

FIG. 1 shows a schematic diagram of a prior art aircraft communication distribution system;

FIG. 2 shows a schematic diagram of an embodiment of an aircraft communication distribution system having an airnet media appliance positioned within a head end unit;

FIG. 3 shows a schematic diagram of an embodiment of an aircraft communication distribution system having an airnet media appliance positioned within a head end unit and a modified overhead section of a seat end unit;

FIG. 4 shows a schematic diagram of an embodiment of an aircraft communication distribution system having an airnet media appliance and an airnet media server positioned within a head end unit and a modified seat end unit;

FIG. 5 shows a schematic diagram of an embodiment of an aircraft communication distribution having an airnet media appliance, an airnet media, and an airnet web server positioned within a head end unit and a modified seat end unit;

FIG. 6 shows a block diagram of an embodiment of a digital head end unit of an aircraft communication distribution system;

FIG. 7 shows a chart of the specifications of an embodiment of a modified head end unit unit of an aircraft communication distribution system;

FIG. 8 shows an chart of an exemplary configuration of a modified head end unit of an aircraft communication distribution system;

FIG. 9 shows a flow chart of an embodiment of an aircraft communication distribution system; and

FIG. 10 shows a schematic diagram of a display unit of an aircraft communication distribution system.

### DETAILED DESCRIPTION OF THE INVENTION

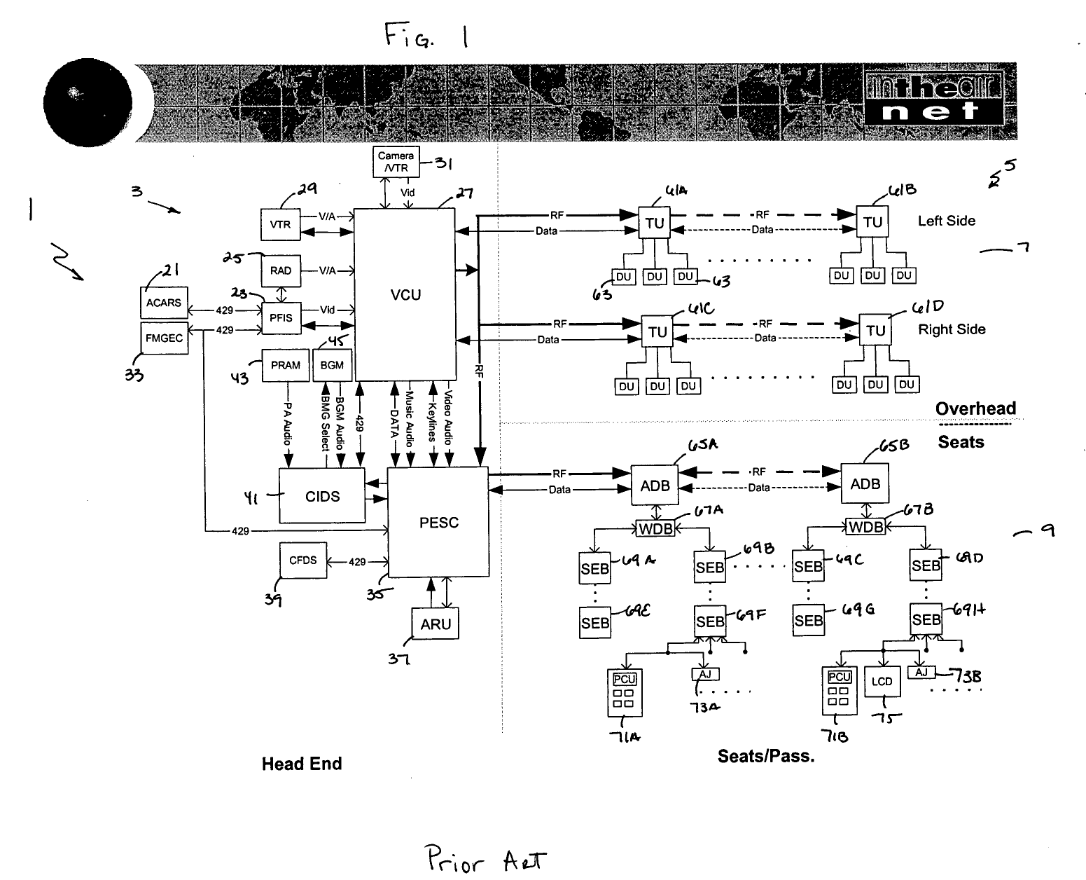

FIG. 1 shows an embodiment of a prior art aircraft communication distribution system. As shown, the aircraft communication distribution system 1 is comprised of a head end unit 3 and a seats/passenger end unit 5. The seats/passenger end unit 5 may further include an overhead section 7 and a seat section 9. Th overhead section 7 displays information to the passengers from overhead mounted display units while the seats/passenger section 9 displays information to the passengers from display units mounted in passenger seats. The head end unit 3 includes an aircraft communication addressing and reporting system (ACARS) 21 in communication with a passenger flight information system (PFIS) 23 through a communication conduit. The PFIS 23 is in communication with a random access device (RAD) 25 and a video control unit (VCU) 27. The PFIS 23 provides and receives video information to and from the VCU 27, while the RAD provides video and audio information to the VCU 27. In addition, at least one video tap reproducer (VTR) 29 may be in communication with the VCU 29 providing and receiving video information thereto and therefrom. In the illustrated configuration, a camera/VTR 31 is shown sending and receiving video information from the VCU 27. The PFIS 23 also sends and receives information from the flight management and guidance envelope computer 33 and the passenger entertainment system controller 35. The PESC 35 provides and receives entertainment information to the VCU 27 in a variety of formats, including, video, audio, keylines, and data. The PESC 35 is in further communication with audio reproducer unit 37, the cabin intercommunication data system (CIDS) 41, and the centralized fault display system (CFDS) 39 which logs all related systems faults. The CIDS 41 is in communication with the pre-recorded announcement and boarding music audio reproducer (PRAM) 43 and the boarding music reproducer (BGM) 45. The various components of the head end unit 3 may be communicate with each in any variety of ways, including, for example, in accordance with ARINC 429 specifications.

As stated above, the seat/passenger end unit 5 may further include an overhead section 7 and a seat section 9. The overhead section 7 may comprise one or more tapping units 61A-61D configured to send and receive information from the VCU 27 and the PEFC 35. Typically, at least one TU 61A-61D will receive analog information from the PESC 35 transmitted in a radio frequency (RF) over a conduit. Optionally, the RF signal may be undergo quadrature amplitude modulation, thereby enabling a digital signal to be encoded in a analog. Further, each at least one TU 61A-61D will send and receive an analog signal from the VCU 27. Each TU 61A-61D may be in communication with at least one display unit 63 for displaying information to a passengers. As shown, TU 61B and 61D communicate with the VCU 27 and the PESC 35 through TU 61A and 61B. As a result, the analog signal received by TU 61B, 61D may become attenuated or otherwise weakened, thereby resulting a poor signal quality to display units 63 in communication therewith.

The seat section 9 includes at least one area distribution box ADB 65A, 65B in communication with the VCU 27 and the PEFC 35. Typically, the ADB 65A, 65B will receive analog information from the PESC 35 transmitted in a radio frequency (RF) over a conduit. Optionally, the RF signal may be undergo quadrature amplitude modulation, thereby enabling a digital signal to be encoded in a analog. Further, the ADB 65A, 65B will send and receive an analog signal from the VCU 27. The ADB 65A, 65B transmits the information to at least one wall distribution box 67A, 67B which is in communication with at least one seat electronics box 69A-69H. One or more seat electronics boxes 69F, 69H may be in communication with a variety of passenger input devices. Exemplary passenger input devices include, for example, passenger control units 71A, 71B, audio jacks 73A, 73B, and display units 75.

Unlike prior art systems, the aircraft communication distribution application disclosed herein may be configured to transmit information to a variety of passenger entertainment units in a variety of formats. In one embodiment, the aircraft communication distribution system may be configured to couple and interface with existing analog-based systems currently in use. In an alternate embodiment, the aircraft communication distribution system replaces existing RF analog systems with a higher quality, lower cost digital system. Optionally, a staggered or phased design approach may be implemented wherein a portion of the passenger compartment would receive a digital signal while another portion of the passenger compartment would receive an analog signal. In short, the aircraft communication distribution system disclosed herein provides a modular systems which may be tailored to a clients specific needs.

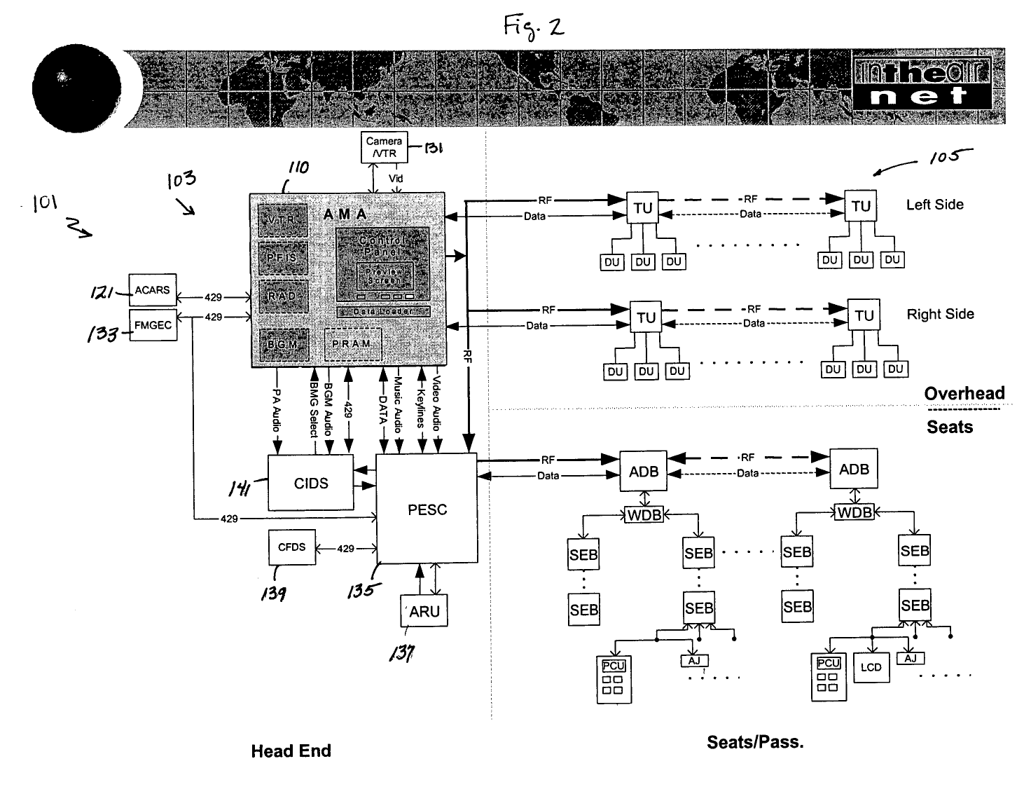

FIG. 2 shows an embodiment of an aircraft communication distribution system. As shown, the aircraft communication distribution system 101 includes a modified head end unit 103 and a seats/passenger end unit 105. The seats/passenger end unit 105 may further include an overhead section 107 and a seat section 109. Th overhead section 107 displays information to the passengers from overhead mounted display units while the seats/passenger section 109 displays information to the passengers from display units mounted in passenger seats. The head end 103 includes an aircraft communication addressing and reporting system (ACARS) 121 in communication with airnet media controller or appliance (AMA) 110. In one embodiment, AMA 110 comprises a digital, multi-function device configured to interface with existing or upgraded in-flight entertainment distribution systems, and may include a built in display device and high speed loaded capable of rapidly accessing memory storage in communication therewith. Optionally, the AMA 110 is configured to store and access digital, analog, or digital and analog information stored therein or in communication therewith. For example, the AMA 110 may include a variety of music files, both analog and digitally stored thereon. Alternatively, the AMA 110 may replace various components of the prior art system shown in FIG. 1 with a singular device. More specifically, the PFIS 23, RAD 25, VCU 27, VTR 29, PRAM 43, BGM 45 of the aircraft communication distribution system 1 shown in FIG. 1 may be replaced with one or AMAs 110.

Referring again to FIG. 2, the AMA 110 is in communication with the FMGEC 131, which is in communication with the PESC 135. The PESC 135 is in communication with AMA 110, the CIDS 141, and the CFDS 139. Optionally, one or more cameras/VTR 131 may communicate with the AMA 110. As shown in FIG. 2, the AMA 110 may replace several components of the head end unit 3 (see FIG. 1) and interfaces with remaining existing in-flight entertainment systems. In addition, the seat end unit 105 of the aircraft communication distribution system 101 may incorporate the components of the seat end unit 5 of the aircraft communication distribution system 1 of FIG. 1. As a result, the AMA 110 may include one or more modulators configured to modulate the digital data stored therein and transmit the modulated signal over existing communication lines, such as RF lines and analog data lines.

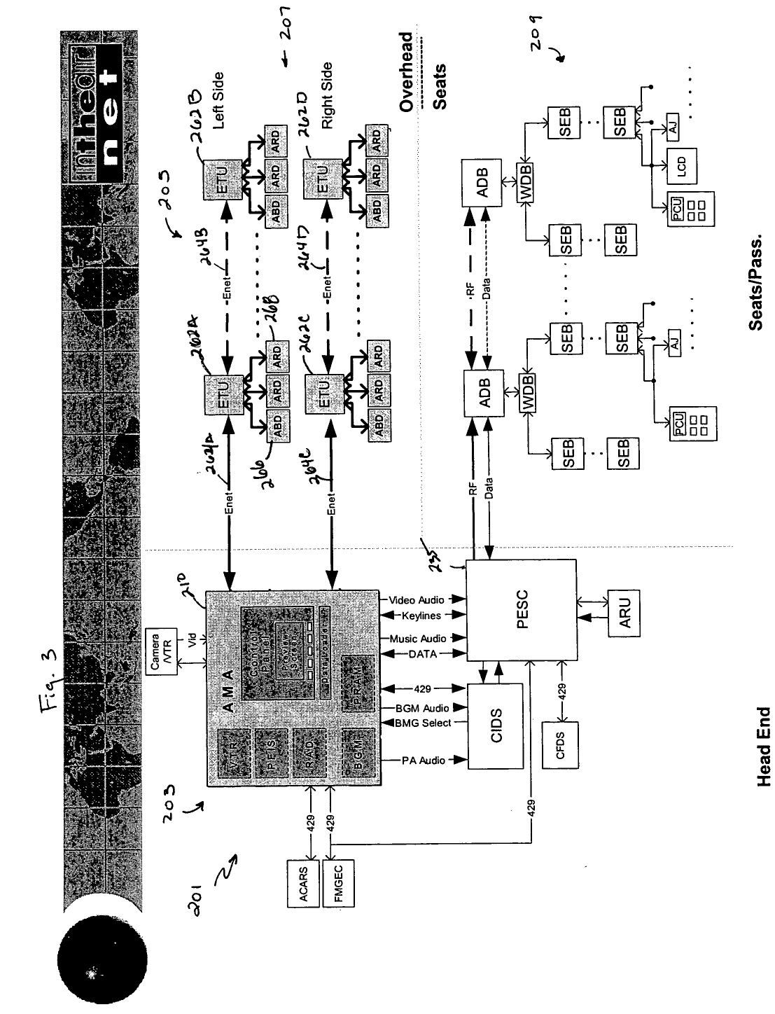

FIG. 3 shows an alternate embodiment of an aircraft communication distribution system. As shown, the aircraft communication distribution system 201 includes a modified head end unit 203 and a seat end unit 205. As shown in FIG. 3, the modified head end unit 203 is identical to the modified head end unit 110 illustrated in FIG. 2 and described above. In the illustrated embodiment, the seat end unit 205 includes a modified overhead section 207 and a seat section 209 similar to the seat section 9 of FIG. 1. In an alternate embodiment, the overhead section 207 may be similar to the overhead section 7 of FIG. 1 while the seat section 209 is modified to receive digital signals from the airnet media appliance 210. The modified overhead section 207 includes at least one Ethernet tapping unit (ETU) 262A-262D in communication with the AMA 210. Exemplary ETUs include 5 port 100BaseT Switches. ETUs 262A, 262C are in communication through with the AMA 210 through Ethernet (Enet) conduits 264A, 262C, respectively. ETUs 262B, 262D communicate with the AMA 210 through Enets, 264B, 264D, which are in communication with ETUs 262A, 262C, respectively. An airnode bulkhead display (ABD), an airnode retractable display (ARD), or both is in communication with at least one ETUs 262A-262D. In the illustrated embodiment, an ABD 266 and 2 ARCs 268 display information received from the ETUs 262A-262D. Optionally, any combination of ABDs 266 and ARDs 268 may be coupled to the ETUs 262A-262D. The modified overhead section 207 sends and receives digital information from the AMA 210 while the seat section 209 sends and receives analog information from the PESC 235. As shown in FIG. 3, the modified overhead section 207 has a singular information path through the Enets 264A-264D, unlike the analog seat section 209 which requires separate lines of communication for RF signals and data signals.

In an alternate embodiment, an airnet media server (AMS) has been developed for replacing the analog PESC 35 and ARU 37 of the head end unit 3 (see FIG. 1) found in prior art systems with a wide variety of digital media formats. In one embodiment, the AMS comprises an open architecture server design housing PESC functions therein and thereby effectively replacing the PESC and ARU. In addition, the AMS may store a variety of audio and/or video files in a variety of formats thereon, thereby providing audio/video on demand capabilities, and may include interactive games and/or third party applications. Optionally, the AMS may be configured to promote laptop connectivity and include one or more modems.

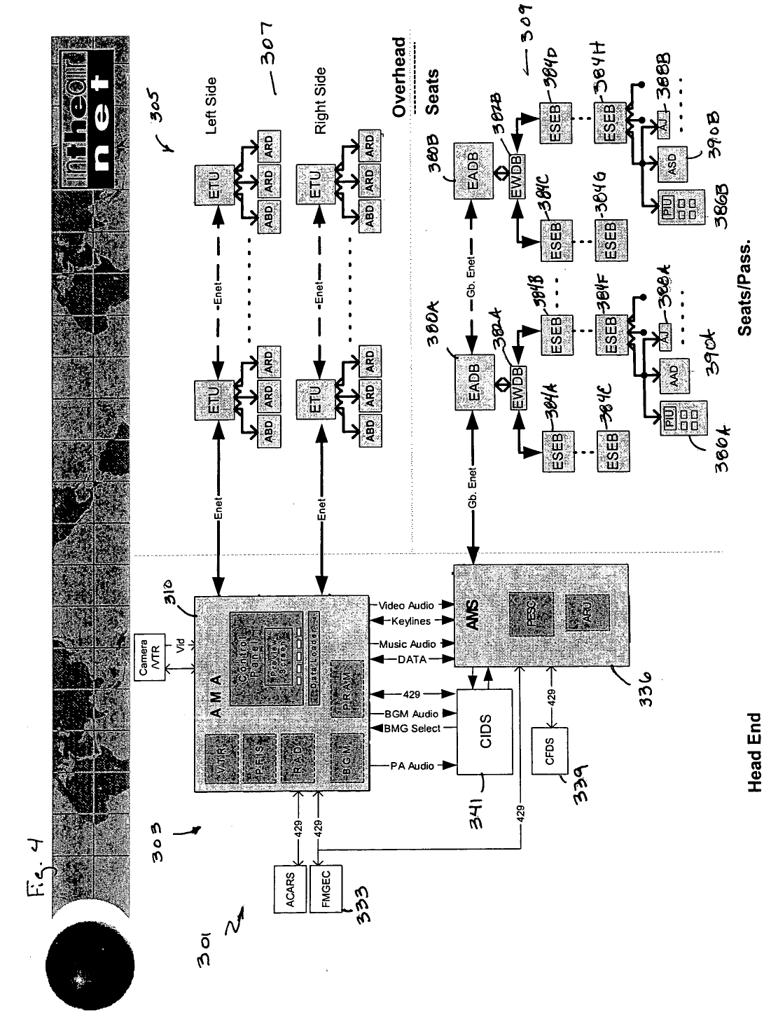

FIG. 4 shows an embodiment of an aircraft communication distribution system 301 having a modified head end unit 303 including an AMS 336. As shown, the AMA 310 is in communication with the modified overhead section 307 of the seat end unit 305. The modified overhead section 307 is similar to the modified overhead section 207 shown in FIG. 3 and described above. The FMGEC 333 is in communication with the AMA 310 and the AMS 336. The AMS 336 is in communication with the, AMA 310, the CFDS 339, and the CIDS 341. As shown in FIG. 4, the AMS 336 have replaced the analog PESC and ARU systems, thereby providing a digital media device. The seat section 309 has been modified to accept information in digital format form the AMS 336. As shown, the modified seat section 309 includes one or more Ethernet area distribution boxes (EADB) 380A, 380B, respectively. Exemplary EADs include gigbit to 100BaseT switches. The EADBs 380A, 380B may be in communication with the AMS 336 and one or more Ethernet wall distribution boxes (EWDB) 382A, 382B, which are in communication with one or more Ethernet seat electronics boxes (ESEB) 384A-384H. Exemplary EWDBs include 5 port 100BaseT switches, while exemplary ESEBs include 8 port 100BaseT switches. At least one passenger input units (PIU) may be coupled to at least one ESEB 384A-384H. In the illustrated embodiment, PIUs 386A, 386B, respectively, are in communication with ESEBs 386F, 386H, respectively. Similarly, one or more audio jacks 388A, 388B and display devices may be coupled to the ESEB 386A-386H. As shown, an airnode inarm display 390A is in communication with ESEB 386F and an airnode seatback display 390B is in communication with ESEB 386H, each of which may be used to display information to the passenger. As shown in FIG. 4, the modified overhead section 307 includes Enet conduits connecting the various components thereof, while the modified seat section 309 includes gigabit Ethernet conduits connecting the various components thereof. As a result, a complete digital in-flight entertainment system is provided.

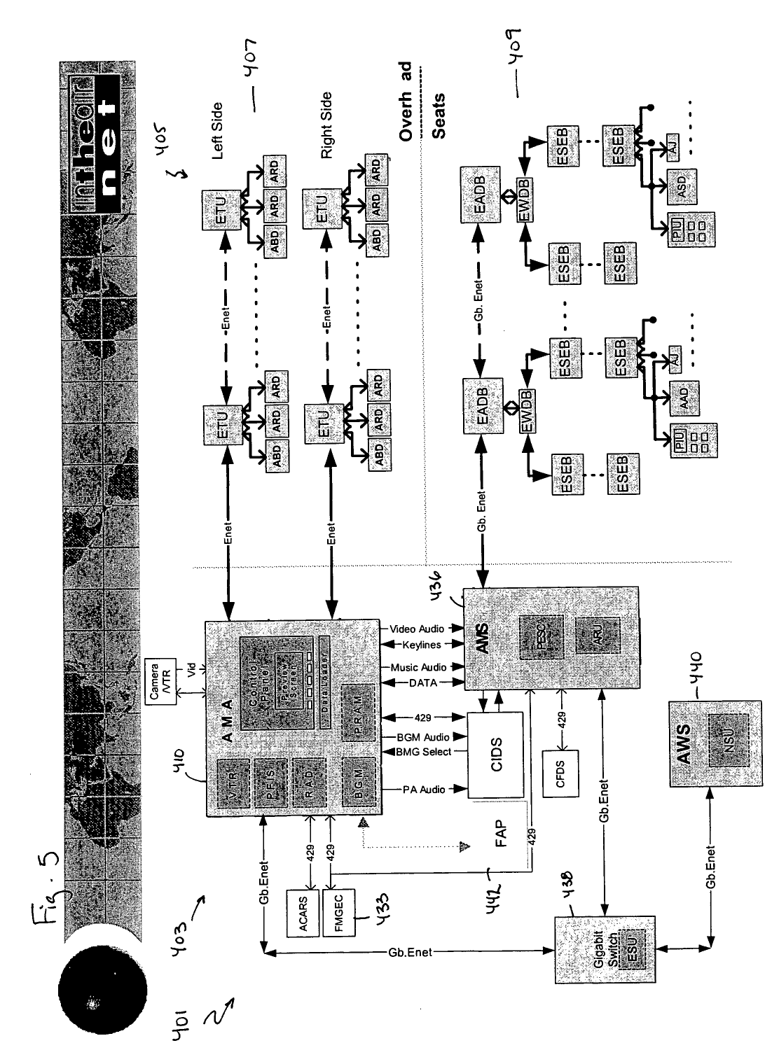

In another embodiment, the aircraft communication distribution system may include an airnet web server. FIG. 5 shows a schematic diagram of an embodiment of an aircraft communication distribution system 401 having an airnet web server (AWS) 440 therein. Optionally, the AWS 440 may be ARINC 763 compliant having an open architecture design offering secure data routing. In one embodiment, the AWS 340 may be configured to host a variety of third party applications and may be configured to interface with telephone modem devices, (POTS systems), ISDN, Ethernet, and be ARINC 429 compliant. As shown In FIG. 5, the modified head end unit 403 includes an AMA 310 in communication with a modified seat end unit 405. The modified seat end unit 405 comprises a modified overhead section 407 and a modified seat section 409. The modified seat section is in communication with the AMS 436. The FMGEC 433 of the modified head unit 403 is in communication with the AMA 410 and the AMS 436. In addition, the AMA 410 is in communication with a gigabit switch 438, which are in communication with the AMS 436 and the AWS 440. Optionally, a flight attendant panel (FAP) 442 may be in communication with the AMA 510. One or more gigabit switches 438 and/or one or more Ethernet switches may be used in any of the aircraft communication distribution systems described above. In an alternate embodiment, wireless access points (WAP) may be positioned within the passenger compartment thereby enabling passengers to wireless access to the communication system.

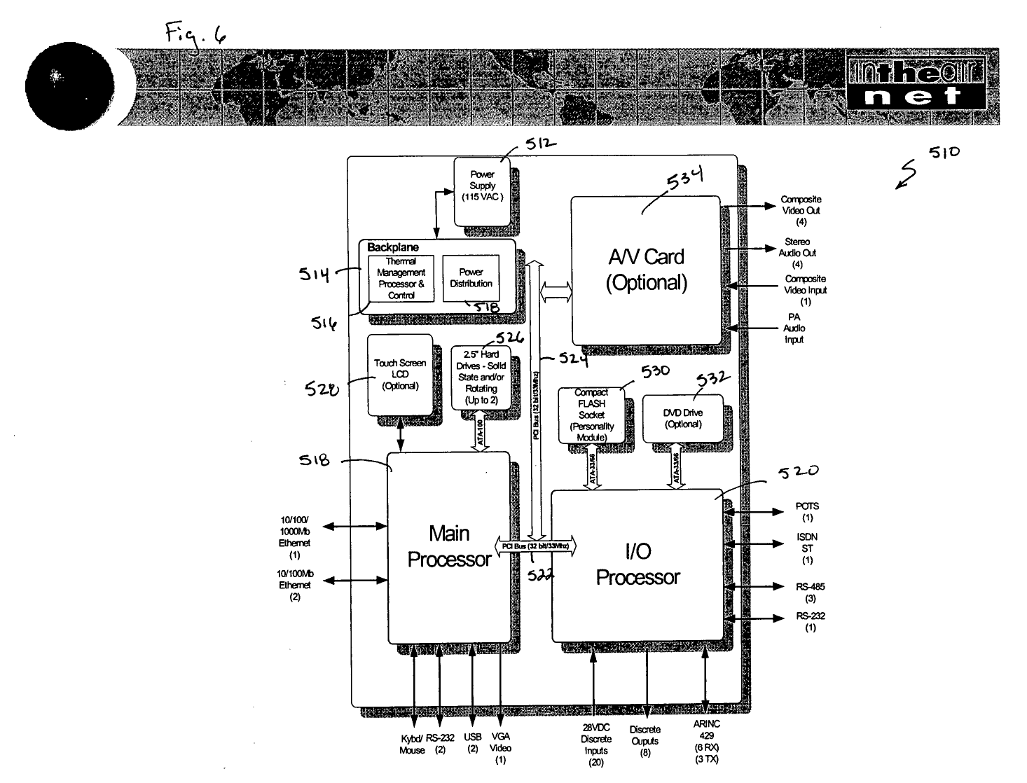

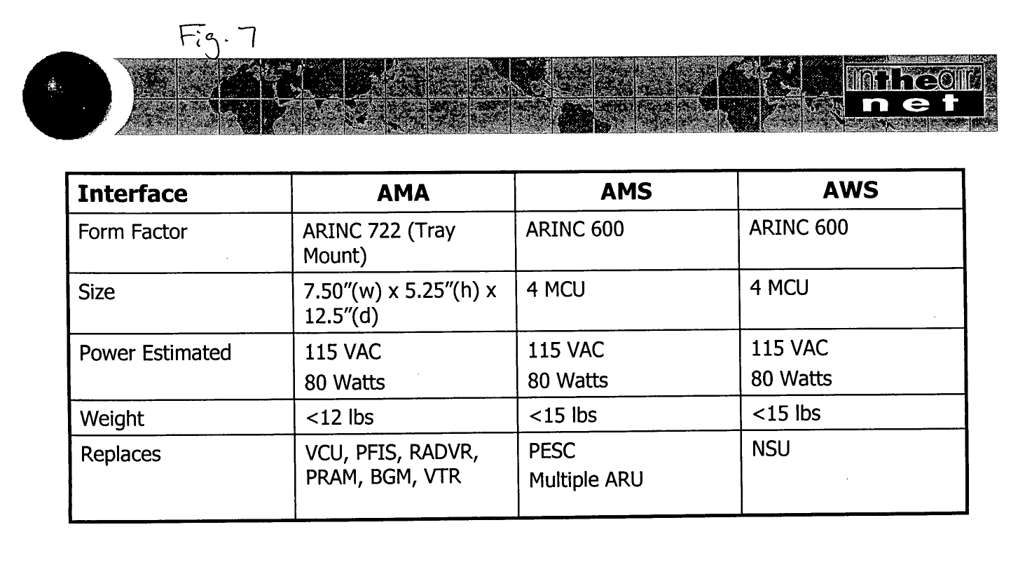

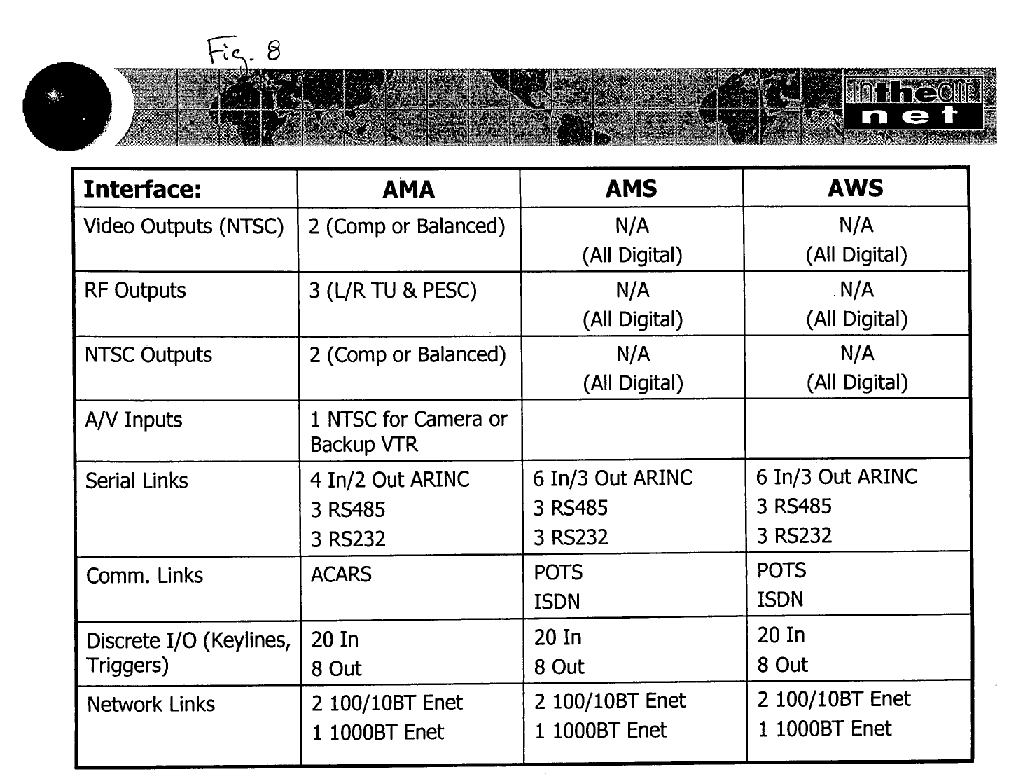

As shown in FIGS. 2-5, the various components of the aircraft communication distribution system disclosed herein may be singularly installed into an existing system or, in the alternative, installed as a complete modified head end unit. FIG. 6 shows an exemplary build out of a modified head end unit 510. The modified head end unit 510 includes power supply 512 in communication with a backplane 514. The backplane may include thermal management processor 514 and power distribution capabilities 518. The modified head end unit 510 further includes a main processor 518 in communication with an I/O processor 520 through an internal bus device 522. At least one memory storage device 526 may be in communication with the main processor 518. Optionally, a user interface 528 may be similarly in communication with the main processor 518. Exemplary user interfaces include touch screen displays. Optionally, the main processor and the I/O processor may be in communication with an A/V card 534 through an internal bus 524. Exemplary internal buses include, for example, PCI buses (32 bit/33 Mhz). FIG. 7 shows a chart of the specifications of an embodiment of a modified head end unit, while FIG. 8 shows an exemplary configuration of a modified head end unit for an aircraft communication distribution system.

In an alternate embodiment, one or more airnet direct broadcasting system (DBS) receivers may be used within an aircraft communication distribution system. The DBS receivers may be configured to receive a variety of broadcast signals and may operable with Ku broadband systems. In one embodiment, the DBS receivers would output signals in NTSC/PAL or digital MPEG2 format, or both. In another embodiment, one or more antenna subsystems may be in communication with the modified head end unit. For example, the antenna subsystems may be capable interfacing with ARINC, ViaSat and Rantec system on Ku broadband integration. Optionally, the antenna system may be comprised of one or more broadband antennas and one or more narrowband antennas.

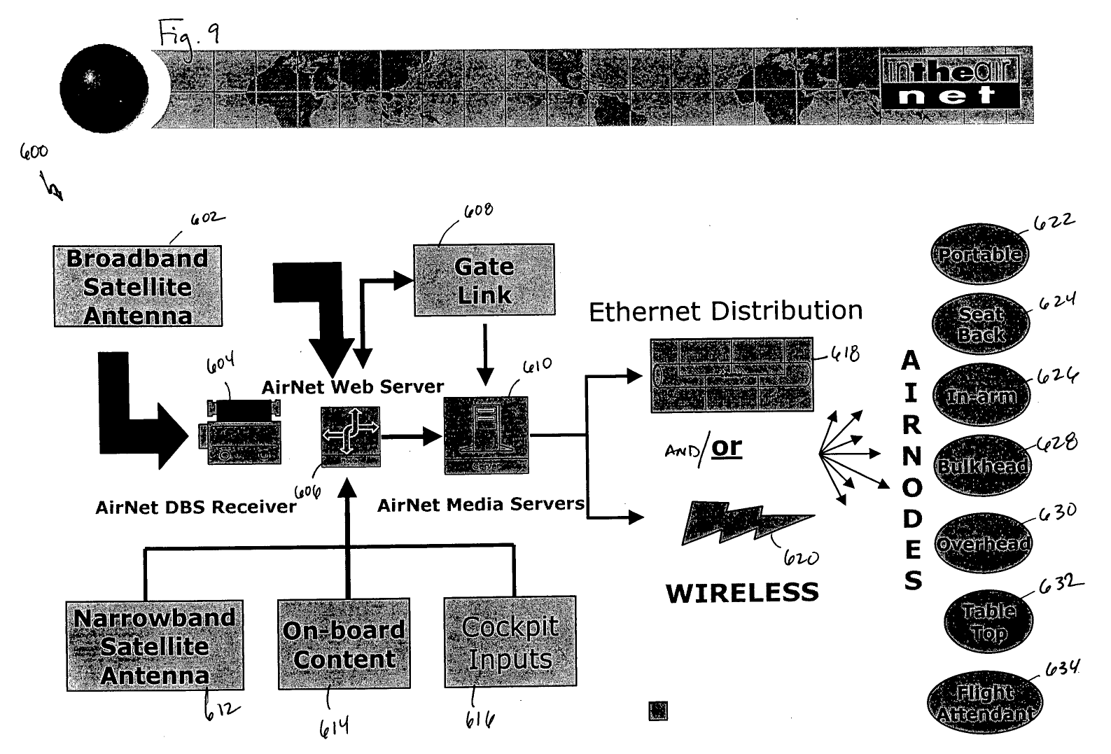

FIG. 9 shows a flow chart of a complete aircraft communication distribution system 600. As shown, a broadband satellite antenna 602 is in communication with a DBS receiver 604 and a airnet web server 606, thereby providing information thereto. Optionally, a gate link may be used to provide information to the aircraft when the aircraft is coupled to or proximate to the gate. The gate link 608 is in communication with a airnet web server 606 and an airnet media server 610. A narrowband satellite antenna 612, an on-board content manager 614, and/or cockpit information inputs 616 may be in communication with and provide information to the airnet web server 606. The airnet web server 606 provides information to the airnet media server 610, which distributes the information in a variety of ways. For example, some or all information may be distributed via an Ethernet 618 to the airnodes. Optionally, some or all the information may be distributed to the airnodes through wireless access points 620. The airnodes receiving the information may include portable devices 622, seatback displays 624, in-arm displays 626, bulkhead displays 628, overhead displays 630, tabletop displays 632, or a flight attendant panel 634.

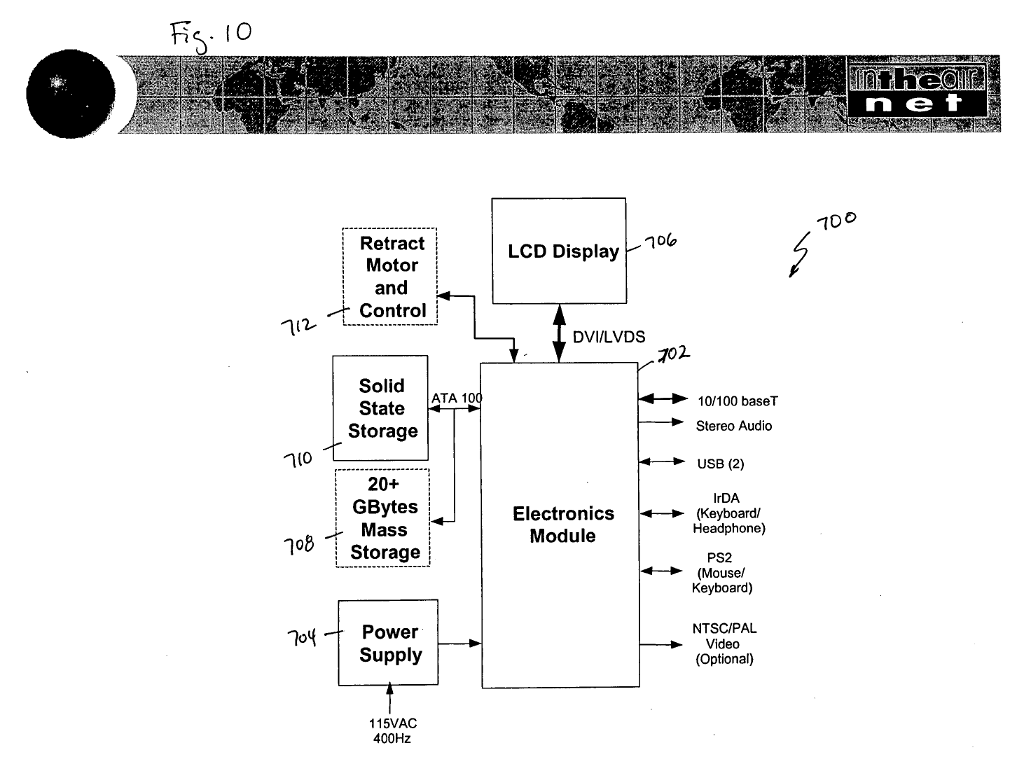

In another embodiment, the aircraft communication distribution system includes one or more “smart” information display modules or airnodes. FIG. 10 shows an exemplary smart display 700 having an electronics module 702 in communication with a power supply, 704, and an LCD display 706. The electronics module includes one or more processors therein capable of providing and retrieving information form multiple storage devices. In the illustrated embodiment, the electronics module 702 is in communication with a mass storage device 708 and a solid state storage device 710. In one embodiment, the electronics module would be configured to interact with a variety of entertainment systems and process a variety of formats. Optionally, the retract motor and control circuit 712 is coupled to the smart display to enable the display to retract into the bulkhead when not in use. The inclusion of processors in each smart display of a display network effectively distributes segments of the server function of prior art systems across the network, thereby eliminating or reducing the need for a dedicated server to control and monitor the network.

In closing, it is understood that the embodiments of the aircraft communication distribution system disclosed herein are illustrative of principles of the invention. Other modifications may be employed which are within the scope of the present invention. Accordingly, the aircraft communication distribution system is not limited to that precisely as shown and described in the present disclosure.

What is claimed is:

1. An aircraft communication distribution system, comprising:
a media controller to control the system;
a media server in communication with the media controller and configured to store media information in a digital format;
a web server to access the worldwide web in communication with the media controller;
at least one Ethernet tapping unit in communication with the media controller;
at least one Ethernet area distribution box in communication with the media server; and
at least one display unit in communication with at least one of the Ethernet tapping unit and the Ethernet area distribution box.

2. The device of claim 1 further comprising one or more Ethernet conduits coupling components of the aircraft communication distribution system together.

3. The device of claim 1 further comprising one or more Ethernet switches positioned within aircraft communication distribution system.

4. The device of claim 1 further comprising one or more gigabit Ethernet switches positioned within aircraft communication distribution system.

5. The device of claim wherein various components communicate with one another through at least one conduit selected from the group consisting of fiber optics, electrical conduits, wireless networks.

6. An aircraft communication distribution system, comprising:
a media controller to control the system;
a media server in communication with the media controller and configured to store media information in a digital format;
a web server to access the worldwide web in communication with the media controller;
at least one display unit in communication with at least one of the media controller and the media server, the display unit having at least one processor, memory device, and display screen therein.

7. An aircraft communication distribution system, comprising:
a media controller to control the system;
a media server in communication with the media controller and configured to store media information in a digital format;
a web server to access the worldwide web in communication with the media controller;
a network of display units in communication with at least one of the media controller and the media server and other display units with the display unit network, each display unit having at least one processor, memory device, and display screen therein, wherein the network of display units forms a distributed server.
